(19) United States
(12) Patent Application Publication
(10) Pub. No.: US 2024/0316908 A1
(43) Pub. Date: Sep. 26, 2024

(54) DECORATIVE FILM, DECORATIVE MOLDED ARTICLE, DECORATIVE DISPLAY COMPONENT, DECORATIVE DISPLAY SYSTEM, AND METHOD FOR MANUFACTURING DECORATIVE DISPLAY COMPONENT

(71) Applicant: Dai Nippon Printing Co., Ltd., Tokyo (JP)

(72) Inventors: Shohei Ishiguro, Tokyo (JP); Hiroyuki Atake, Tokyo (JP)

(73) Assignee: Dai Nippon Printing Co., Ltd., Tokyo (JP)

(21) Appl. No.: 18/578,399

(22) PCT Filed: Jul. 12, 2022
(86) PCT No.: PCT/JP2022/027475

§ 371 Date: Jan. 11, 2024

(30) Foreign Application Priority Data
Jul. 12, 2021 (JP) 2021-115151

(51) Int. Cl. B32B 27/08; B29C 45/14; B29L 31/34; B32B 3/30; B32B 7/02; B32B 27/30; F21V 11/08; F21W 121/00

(52) U.S. Cl. CPC B32B 27/08; B32B 3/30; B32B 7/02; B32B 27/302; B32B 27/308; F21V 11/08; B29C 45/14688; B29C 2045/1486; B29L 2031/3475; B32B 2250/24; B32B 2255/10; B32B 2255/26; B32B 2307/412; B32B 2307/7376; B32B 2451/00; B32B 2457/20; F21W 2121/00

(57) ABSTRACT

A decorative molded article undergoes laser etching. The decorative molded article includes: a first top layer containing a cured product of an ionizing radiation-curable resin; a transparent second top layer laminated with the first top layer; and a design layer located between the first top layer and the second top layer.

### TECHNICAL FIELD

The present invention relates to a decorative film, a decorative molded article, a decorative display component, a decorative display system, and a method for manufacturing a decorative display component.

### BACKGROUND ART

PTL 1 (JP 2002-46145 A) discloses a decorative film having a decorative area with printing and a non-decorative area without printing. The decorative film in PTL 1 is joined to a resin portion formed by injection molding, and the decorative film together with the resin portion constitutes a decorative display component. In PTL 1, the decorative display component is disposed to face a light source. The decorative sheet is illuminated with light from the light source from the back. At this time, the pattern corresponding to the pattern of the non-decorative area is displayed.

In PTL 1, the decorative display component is manufactured by insert molding. This example requires positioning the decorative film having a decorative area and a non-decorative area with respect to a mold used for insert molding. Instead of the manufacturing method in PTL 1, the decorative display component may also be manufactured by attaching a decorative film to a preformed resin portion. However, this manufacturing method also requires positioning the decorative film with respect to the resin portion. If the positional relationship between the decorative film and the resin portion is not appropriate, the decorative display component is not provided with expected design quality.

### SUMMARY OF INVENTION

The present disclosure is intended to improve the design quality of decorative display components.

A first decorative film according to an embodiment of the present disclosure is
a decorative film that undergoes laser etching,
wherein the decorative film includes:
   a first top layer containing a cured product of an ionizing radiation-curable resin;
   a transparent second top layer laminated with the first top layer; and
   a design layer located between the first top layer and the second top layer.

A second decorative film according to an embodiment of the present disclosure includes:
a first top layer containing a cured product of an ionizing radiation-curable resin;
a transparent second top layer laminated with the first top layer;
a design layer located between the first top layer and the second top layer; and
a thermoplastic resin layer laminated with the second top layer and containing a thermoplastic resin,
wherein the second top layer is located between the design layer and the thermoplastic resin layer.

A decorative molded article according to an embodiment of the present disclosure includes:
the decorative film according to any one of the embodiments of the present disclosure; and
a resin portion laminated with the decorative film and containing a thermoplastic resin.

A first decorative display component according to an embodiment of the present disclosure includes
the decorative molded article according to the embodiment of the present disclosure,
wherein the second top layer is exposed from a hole passing through the first top layer and the design layer.

A second decorative display component according to an embodiment of the present disclosure includes:
a decorative film; and
a resin portion laminated with the decorative film and containing a thermoplastic resin,
wherein the decorative film includes:
   a first top layer containing a cured product of an ionizing radiation-curable resin;
   a transparent second top layer laminated with the first top layer; and
   a design layer located between the first top layer and the second top layer,
the second top layer is located between the design layer and the resin portion, and
the second top layer is exposed from a hole passing through the first top layer and the design layer.

A decorative display system according to an embodiment of the present disclosure includes:
the decorative display component according to the embodiment of the present disclosure; and
a light source that emits light to the decorative display component.

A method for manufacturing a decorative display component according to an embodiment of the present disclosure includes:
a step of producing a decorative molded article by bonding the decorative film according to an embodiment of the present disclosure to a resin portion formed by injection molding; and
a step of partially removing the first top layer and the design layer by laser etching so that the second top layer forms part of a surface.

The present disclosure can improve the design quality of decorative display components.

### BRIEF DESCRIPTION OF DRAWINGS

FIG. 1 is a schematic perspective view of an example decorative system according to an embodiment.

FIG. 2 is a plan view of the decorative display system in FIG. 1 with a light source off as viewed from the front.

FIG. 3 is a plan view of the decorative display system in FIG. 1 with a light source on as viewed from the front.

FIG. 4 is a partial cross-sectional view of the decorative display system in FIG. 1.

FIG. 5 illustrates an example method for manufacturing the decorative film shown in FIG. 4.

FIG. 6 illustrates the example method for manufacturing the decorative film shown in FIG. 4.

FIG. 7 illustrates the example method for manufacturing the decorative film shown in FIG. 4.

FIG. 8 illustrates the example method for manufacturing the decorative film shown in FIG. 4.

FIG. 9 illustrates preforming in the example method for manufacturing the decorative display component shown in FIG. 4.

FIG. 10 illustrates preforming in the example method for manufacturing the decorative display component shown in FIG. 4.

FIG. 11 illustrates preforming in the example method for manufacturing the decorative display component shown in FIG. 4.

FIG. 12 illustrates preforming in the example method for manufacturing the decorative display component shown in FIG. 4.

FIG. 13 illustrates insert molding in the example method for manufacturing the decorative display component shown in FIG. 4.

FIG. 14 illustrates insert molding in the example method for manufacturing the decorative display component shown in FIG. 4.

FIG. 15 illustrates insert molding in the example method for manufacturing the decorative display component shown in FIG. 4.

FIG. 16 illustrates insert molding in the example method for manufacturing the decorative display component shown in FIG. 4.

FIG. 17 illustrates laser etching in the example method for manufacturing the decorative display component shown in FIG. 4.

FIG. 18 is a cross-sectional view of a decorative film according to one modification, wherein the cross-sectional view is similar to FIG. 4.

FIG. 19 is a cross-sectional view of a decorative film according to another modification, wherein the cross-sectional view is similar to FIG. 4.

FIG. 20 is a cross-sectional view of a decorative film according to another modification, wherein the cross-sectional view is similar to FIG. 4.

FIG. 21 is a cross-sectional view of a decorative film according to another modification, wherein the cross-sectional view is similar to FIG. 4.

FIG. 22 is a cross-sectional view of a decorative film according to another modification, wherein the cross-sectional view is similar to FIG. 4.

### DESCRIPTION OF EMBODIMENTS

Embodiments of the present disclosure relate to the following [1] to [22].

[1] A decorative film that undergoes laser etching, including:
a first top layer containing a cured product of an ionizing radiation-curable resin;
a transparent second top layer laminated with the first top layer; and
a design layer located between the first top layer and the second top layer.

[2] The decorative film according to [1], wherein the second top layer forms a surface of the decorative film together with the first top layer after the first top layer and the design layer are partially removed by the laser etching.

[3] The decorative film according to [1] or [2], further including a thermoplastic resin layer laminated with the second top layer and containing a thermoplastic resin,
wherein the second top layer is located between the design layer and the thermoplastic resin layer.

[4] A decorative film including:
a first top layer containing a cured product of an ionizing radiation-curable resin;
a transparent second top layer laminated with the first top layer;
a design layer located between the first top layer and the second top layer; and
a thermoplastic resin layer laminated with the second top layer and containing a thermoplastic resin,
wherein the second top layer is located between the design layer and the thermoplastic resin layer.

[5] The decorative film according to [3] or [4], wherein the thermoplastic resin layer has a thickness of 100 μm or more and 1000 μm or less.

[6] The decorative film according to any one of [1] to [5], wherein the second top layer contains an acrylic resin.

[7] The decorative film according to any one of [1] to [6], wherein
the second top layer has a base layer containing an acrylonitrile-butadiene-styrene copolymer and a cover layer covering the base layer, and
the cover layer is located between the base layer and the design layer.

[8] The decorative film according to any one of [1] to [6], wherein
the second top layer has a base layer containing an acrylic resin and a cover layer covering the base layer, and
the cover layer is located between the base layer and the design layer.

[9] The decorative film according to any one of [1] to [8], wherein
the first top layer has a first layer and a second layer laminated with part of the first layer,
the first layer and the second layer are laminated in this order with the design layer, and
the first layer and the second layer have different glossiness.

[10] The decorative film according to [9], wherein
the first top layer further has a projection layer having a plurality of projecting parts,
the plurality of projecting parts is spaced apart from each other, and
the projecting parts have a thickness of 5 μm or more and 50 μm or less.

[11] The decorative film according to any one of [1] to [10], wherein a surface constituted by the first top layer has unevenness in the decorative film according to an embodiment of the present disclosure.

[12] The decorative film according to any one of [1] to [11], further including a second design layer laminated with the second top layer,
wherein the second top layer is located between the design layer and the second design layer.

[13] A decorative molded article including:
the decorative film according to any one of [1] to [12]; and
a resin portion laminated with the decorative film and containing a thermoplastic resin.

[14] A decorative display component including the decorative molded article according to [13],
wherein the second top layer is exposed from a hole passing through the first top layer and the design layer.

[15] A decorative display component including:
a decorative film; and
a resin portion laminated with the decorative film and containing a thermoplastic resin,
wherein the decorative film includes:
   a first top layer containing a cured product of an ionizing radiation-curable resin;
   a transparent second top layer laminated with the first top layer; and
   a design layer located between the first top layer and the second top layer, the second top layer is located between the design layer and the resin portion, and
the second top layer is exposed from a hole passing through the first top layer and the design layer.

[16] The decorative display component according to [14] or [15], wherein the second top layer is exposed from the hole provided in the first top layer and the design layer to form a surface of the decorative display component.

[17] The decorative display component according to any one of [14] to [16], wherein the resin portion has a larger thickness than the second top layer.

[18] A decorative display system including:
the decorative display component according to any one of [14] to [17]; and
a light source that emits light to the decorative display component.

[19] A method for manufacturing a decorative display component, the method including:
a step of producing a decorative molded article by joining the decorative film according to any one of [1] to [12] to a resin portion formed by injection molding; and
a step of partially removing the first top layer and the design layer by laser etching so that the second top layer forms part of a surface.

[20] The method for manufacturing a decorative display component according to [19], wherein the step of producing the decorative molded article involves supplying a heated thermoplastic resin into a cavity accommodating the decorative film to produce the decorative molded article.

[21] The method for manufacturing a decorative display component according to [20], further including a step of preforming the decorative film to deform the decorative film,
wherein the preformed decorative film is placed in the cavity.

[22] The method for manufacturing a decorative display component according to [19] to [21], further including a step of producing the decorative film,
wherein the step of producing the decorative film has a step of forming the design layer on the second top layer by printing, and a step of applying a composition containing an ionizing radiation-curable resin onto the design layer and curing the composition.

Embodiments of the present disclosure will be described below with reference to the drawings. In the drawings attached to this description, the scale, the aspect ratio, and other features are appropriately changed and exaggerated from actual ones for ease of illustration and understanding. The scale, the aspect ratio, and other features may be different between the figures.

The terms such as “perpendicular” and “identical,” and the length values or other values for specifying the shapes, the geometrical conditions, and their degrees, as used herein, are not limited to strict meanings, and construed to include ranges in which similar functionality may be expected.

In this description, the terms “film”, “sheet”, and “plate”, and other terms are not distinguished from each other on the basis of only differences in their names. For example, the term “decorative film” may not be distinguished from a part called a decorative sheet or decorative plate or other similar parts on the basis of only differences in their names.

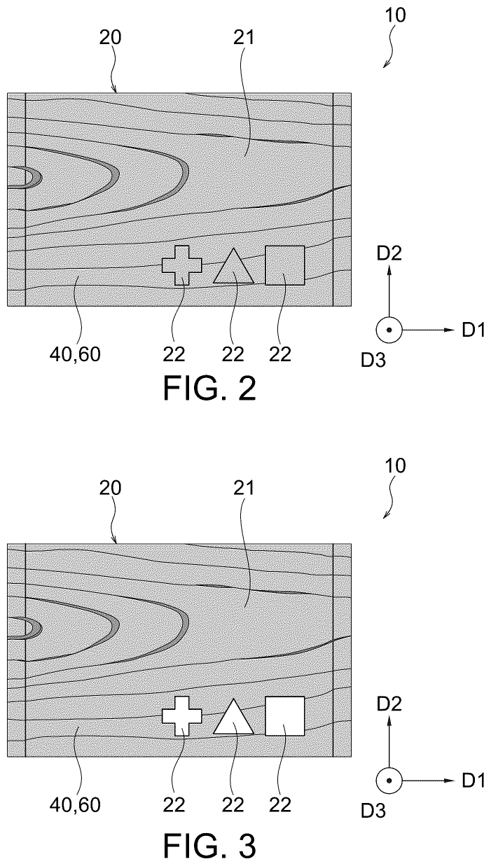

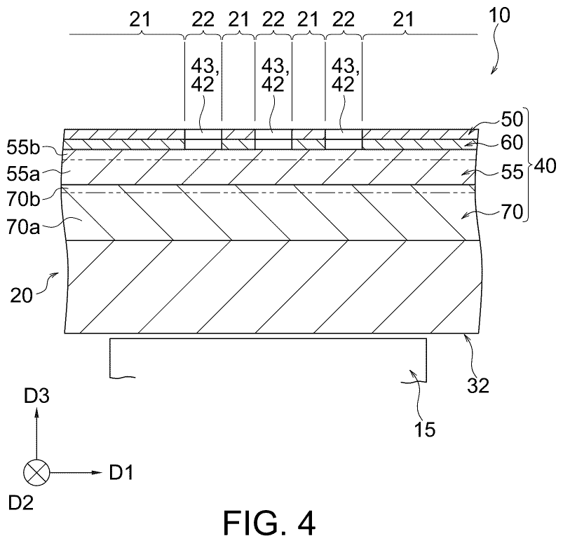

To clarify the directional relationships between the figures, the same directions are indicated by arrows assigned with the same reference signs in some of the figures. The tip of an arrow points one side in the corresponding direction. An arrow pointing from the plane of a figure toward the front in a direction perpendicular to the plane of the figure is denoted by a circle with a dot inside, for example, as illustrated in FIG. 2. An arrow pointing from the plane of a figure toward the back in the direction perpendicular to the plane of the figure is denoted by a circle with a cross inside, for example, as illustrated in FIG. 4.

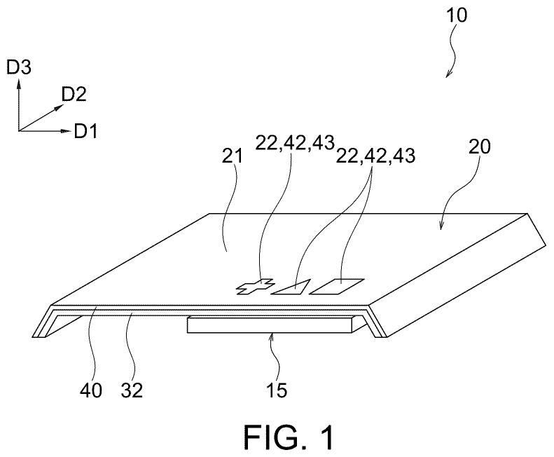

FIG. 1 to FIG. 22 describe embodiments. FIG. 1 is a schematic perspective view of a specific example of a decorative display system.

A decorative display component 20 includes a decorative film 40. The decorative film 40 displays a design. The decorative film 40 includes a design layer 60 forming a design expressed by the decorative film 40. Referring to FIG. 1 to FIG. 4, the decorative display component 20 includes a design section 21 and display sections 22. The design section 21 is a region where the design layer 60 is provided. In the design section 21, the design layer 60 displays a design. Referring to FIG. 4, the decorative film 40 includes non-formation sections 42 in which the design layer 60 does not exist. The display sections 22 are regions where the non-formation sections 42 are located. The display sections 22 and the non-formation sections 42 are constituted by holes 43 in the design layer 60.

Referring to FIG. 1, a decorative display system 10 has a light source 15 and the decorative display component 20. The light source 15 may be a light emitter, such as a light emitting diode (LED) or a cold cathode tube. The light source 15 may have a light emitter and an optical part that controls the orientation of light from the light emitter. The light source 15 may be a light source device that emits planar light. Referring to FIG. 1 and FIG. 4, the light source 15 is covered by the decorative display component 20 from a third direction D3. The light source 15 is hidden by the decorative film 40 as viewed from an observer that observes the decorative film 40. Referring to FIG. 4, the light source 15 faces the display sections 22 of the decorative display component 20 in the third direction D3.

In FIG. 2, the light source 15 is off. A region where the light source 15 is disposed may be covered with the decorative display component 20, parts around the decorative display component 20, or other parts. The region where the light source 15 is disposed is darkened by being covered with the decorative display component 20. At this time, the design section 21 of the decorative display component 20 appears dark. The decorative display component 20 thus hides the light source 15, and the display sections 22 become less noticeable. An observer easily observes the design displayed by the decorative film 40 in the design section 21 of the decorative display component 20. In the illustrated example, the decorative film 40 expresses a wood grain pattern.

In FIG. 3, the light source 15 is on. The display sections 22 of the decorative display component 20 have visible light transparency. The light from the light source 15 thus passes through the design section 21. This allows an observer to observe the display sections 22 brightly. In other words, the pattern of the display sections 22 is displayed. In the illustrated example, the cross, the triangle, and the square are displayed.

The term “visible light transparency” as used herein refers to a visible light transmittance of 50% or more, preferably 80% or more. The term “transparent” used for elements included in the decorative display component refers to transparency that may impart the display sections 22 to visible light transparency. A second top layer 55 described below is transparent if the display sections 22 formed by part of the second top layer 55 have visible light transparency. The term “visible light-shielding properties” refers to a visible light transmittance of 5% or less, preferably 1% or less. The visible light transmittance is specified as the average value of the total light transmittance measured at an angle of incidence of 0° at every 1 nm in the range of measurement wavelength of 380 nm to 780 nm by using a spectrophotometer (“UV-3100PC” manufactured by Shimadzu Corporation, compliant with JIS K 0115).

The decorative display system 10 can be applied to various applications. The decorative display system 10 may be applied to interiors and exteriors of mobile bodies. Mobile bodies are movable devices. Examples of mobile bodies include automobiles, ships, airplanes, railway vehicles, drones, and robots. In one specific example, the decorative display system 10 may be applied to interiors and exteriors of automobiles. The decorative display system 10 may be applied to walls, doors, ceilings, and other parts as interiors of buildings. The decorative display system 10 may be applied to various devices such as furniture and home appliances. In a more specific example, the decorative display system 10 may be applied to desks. The decorative display system 10 may be applied to casings of refrigerators and other equipment.

Embodiments described below in detail are configured to improve the design quality of the decorative display component 20. More specifically, there is a technique for disposing the display sections 22 at appropriate positions in the decorative display component 20. In this embodiment, the display sections 22 of the decorative display component 20 are disposed at appropriate positions, which can avoid deterioration in the design quality of the decorative display component 20.

Embodiments will be described below with reference to the illustrated specific examples.

The decorative display component 20 illustrated in FIG. 1 spreads like a sheet in general observation. The decorative display component 20 spreads in a first direction D1 and a second direction D2. The decorative display component 20 includes elements 32 and 40 laminated in the third direction D3. The decorative film 40 includes elements 50, 60, 55, and 70 laminated in the third direction D3. In other words, the third direction D3 is the lamination direction. In the illustrated example, the first direction D1, the second direction D2, and the third direction D3 are perpendicular to each other.

The decorative display component 20 overlays the light source 15. Referring to FIG. 3, the decorative display component 20 has the design section 21 and the display sections 22. The display sections 22 face the light source 15 in the third direction D3. The display sections 22 have visible light transparency. When the display sections 22 are illuminated with light from the light source 15, the patterns of the display sections 22 appear bright. The decorative display component 20 displays the design in the design section 21. In other words, the decorative display component 20 displays the design in the design section 21 and displays specific patterns in the display sections 22. The decorative display component 20 may have visible light-shielding properties in the design section 21. In this example, the clarity of the display in the patterns corresponding to the patterns of the display sections 22 can be improved when the light source 15 is turned on. The decorative display component 20 may have a thickness of 0.5 mm or more and 10 mm or less in the third direction D3.

The pattern of the display section 22 is not limited. The pattern of the display sections 22 may be appropriately selected according to a target to be displayed by turning the light source 15 on. The display section 22 may have a pattern expressing a figure, a design, a character, a mark, a pictogram, a letter, a number, or other symbols.

Referring to FIG. 4, the decorative display component 20 has the decorative film 40 and a resin portion 32. The resin portion 32 may be formed by injection molding. The decorative film 40 and the resin portion 32 are laminated in the third direction D3. The decorative film 40 has a first top layer 50, the design layer 60, and the second top layer 55. The first top layer 50, the design layer 60, and the second top layer 55 are laminated in this order in the third direction D3. In the illustrated example, the decorative film 40 further has a thermoplastic resin layer 70. The thermoplastic resin layer 70 functions as a backer layer for reinforcing the decorative film 40. The thermoplastic resin layer 70 is laminated with the second top layer 55 in the third direction D3. The thermoplastic resin layer 70 is located between the second top layer 55 and the resin portion 32 in the third direction D3.

The first top layer 50 forms a surface of the decorative display component 20 on the observer side. The first top layer 50 is transparent. The design layer 60 can be observed through the transparent first top layer 50. In other words, the design displayed by the design layer 60 can be observed by an observer through the first top layer 50. The first top layer 50 has physical properties required for the surface. For example, the first top layer 50 may excel in one or more of scratch resistance, abrasion resistance, chemical resistance, stain resistance, light resistance, heat resistance, and moisture resistance. The first top layer 50 may have a thickness of 1 μm or more and 1000 μm or less in the third direction D3.

The first top layer 50 contains a cured product of an ionizing radiation-curable resin. The cured product of the ionizing radiation-curable resin is produced by curing a composition containing the ionizing radiation-curable resin through cross-linking. The ionizing radiation-curable resin has an energy quantum that may allow crosslinking and polymerization of molecules in electromagnetic waves or charged particle beams. The ionizing radiation-curable resin is crosslinked and cured when irradiated with UV light, an electron beam, or other rays. The cured product of the ionizing radiation-curable resin is produced by curing a composition containing the ionizing radiation-curable resin through cross-linking.

The ionizing radiation-curable resin may be appropriately selected from commonly used polymerizable monomers, polymerizable oligomers, and prepolymers. The ionizing radiation-curable resin may be a UV-curable resin, which is cured when irradiated with UV light, or an electron beam-curable resin, which is cured when irradiated with an electron beam. The composition containing the ionizing radiation-curable resin may contain a thermoplastic resin or a thermosetting resin.

The composition containing the ionizing radiation-curable resin may contain an additive according to the physical properties required for the first top layer 50 depending on, for example, the application of the decorative display component 20. Examples of the additive include abrasion resistance improvers, polymerization inhibitors, cross-linkers, UV absorbers, infrared absorbers, antistatic agents, adhesion improvers, light stabilizers, leveling agents, coupling agents, plasticizers, and colorants.

The composition containing the ionizing radiation-curable resin may contain a matting agent. The glossiness of the first top layer 50 can be adjusted by a matting agent. Examples of the matting agent include inorganic particles, such as silica particles, calcium carbonate particles, barium sulfate particles, alumina particles, glass balloon particles; and resin particles, such as urethane beads, acrylic beads, silicone beads, and styrene beads.

A design is formed in the design layer 60. In the design layer 60, a pictorial pattern such as a figure, a pattern, a design, colors, a picture, a photo, a character, a mark, a pictogram, a letter, and a number may be provided as the design. The design layer 60 may express a background design. For example, the design layer 60 may display a wood-grain or marble pattern, a metallic appearance, or a geometric pattern as a design that allows harmonization of the decorative film 40 with the surrounding environment of the decorative display system 10. The design layer 60 may be formed by printing. The design layer 60 may be formed by transfer. The design layer 60 may have a thickness of 1 μm or more and 30 μm or less in the third direction D3.

The design layer 60 may have a binder resin and a color material dispersed in the binder resin. The color material may be a pigment, a dye, or a combination of a pigment and a dye. Examples of the binder resin include acrylic resins, such as polymethyl methacrylate, polyurethane resin, vinyl chloride-vinyl acetate copolymer, vinyl chloride-vinyl acetate-acrylic copolymer, chlorinated polypropylene resin, polyester resin, polyamide resin, butyral resin, polystyrene resin, nitrocellulose resin, and cellulose acetate resin. These materials may be used alone or in combination of two or more.

Referring to FIG. 2 to FIG. 4, the decorative film 40 has non-formation sections 42 where neither the first top layer 50 nor the design layer 60 is provided. In the first top layer 50 and the design layer 60, holes 43 are provided. The non-formation sections 42 may be constituted by the holes 43. The first top layer 50 and the design layer 60 are not laminated on the entire surface of the second top layer 55. The first top layer 50 and the design layer 60 are laminated on part of the second top layer 55. The display sections 22 of the decorative display component 20 are formed in regions where the non-formation sections 42 of the decorative film 40 are located. In other words, the display sections 22 of the decorative display component 20 are formed in regions where the holes 43 are provided in the first top layer 50 and the design layer 60. The second top layer 55 is exposed in the display sections 22. In the display sections 22, the second top layer 55 forms the surface of the decorative display component 20 together with the first top layer 50. The decorative display component 20 has visible light transparency in the display sections 22. The design section 21 of the decorative display component 20 is formed in a region where the first top layer 50 and the design layer 60 are located.

The second top layer 55 is transparent and imparts visible light transparency to the display sections 22 of the decorative display component 20. The second top layer 55 may have a visible light transmittance of 50% or more. The second top layer 55 may have a thickness of 1 μm or more, or 5 μm or more along the third direction D3. Formation of through-holes in the second top layer 55 during laser etching described below can be suppressed by setting the lower limit on the thickness of the second top layer 55. The second top layer 55 may have a thickness of 500 μm or less, or 300 μm or less along the third direction D3. Formability of the decorative film 40 can be improved by setting the upper limit on the thickness of the second top layer 55.

The second top layer 55 forms the surfaces of the display sections 22 of the decorative display component 20 on the observer side. The second top layer 55 has physical properties required for the surface. For example, the second top layer 55 may excel in one or more of scratch resistance, abrasion resistance, chemical resistance, stain resistance, light resistance, heat resistance, and moisture resistance.

The second top layer 55 may be a film. It is easy to handle the second top layer 55 as a film. The second top layer 55 may be a resin film. To improve formability, the second top layer 55 preferably contains a thermoplastic resin, more preferably is made of a thermoplastic resin. Examples of the thermoplastic resin include acrylic resins, polyolefin resins, such as polypropylene and polyethylene, polycarbonate, acrylonitrile-butadiene-styrene copolymer (hereinafter also referred to as “ABS resin”), and vinyl chloride resin. The second top layer 55 may include two or more layers made of these materials.

In application of automotive interior materials, the second top layer 55 may be an acrylic resin film, more specifically a polymethyl methacrylate film. Acrylic resins, such as polymethyl methacrylate, have physical properties required for the surface layers of interior materials used in automobiles.

The second top layer 55 may contain an additive according to the physical properties required for the second top layer 55 depending on, for example, the application of the decorative display component 20. Examples of the additive include abrasion resistance improvers, UV absorbers, infrared absorbers, antistatic agents, adhesion improvers, and colorants. The second top layer 55 may contain a matting agent. The glossiness of the design layer 60 can be adjusted by using a matting agent. Examples of the matting agent include inorganic particles, such as silica particles, calcium carbonate particles, barium sulfate particles, alumina particles, glass balloon particles; and resin particles, such as urethane beads, acrylic beads, silicone beads, and styrene beads.

As indicated by two-dot-dash lines in FIG. 4, the second top layer 55 may have a base layer 55a and a cover layer 55b covering the base layer 55a. As indicated by two-dot-dash lines in FIG. 4, the cover layer 55b is located between the design layer 60 and the base layer 55a in the third direction D3. The cover layer 55b forms the surface of the decorative display component 20 in the display sections 22 of the decorative display component 20. The cover layer 55b has physical properties required for the surface. Examples of the material of the base layer 55a include acrylic resins from the viewpoint of good transparency. The base layer 55a may have physical properties with good formability. Examples of the material of the base layer 55a include ABS resin and vinyl chloride resin, which have better formability than acrylic resins.

The base layer 55a may be a film. It is easy to handle the second top layer 55 as a film. The second top layer 55 may be a resin film. The cover layer 55b may be formed on the base layer 55a composed of a resin film.

The cover layer 55b may contain a cured product of a resin composition containing a thermoplastic resin and an ionizing radiation-curable resin. The ratio of the ionizing radiation-curable resin to the thermoplastic resin may be ionizing radiation-curable resin:thermoplastic resin=10:90 to 25:75 in terms of mass ratio.

Examples of the thermoplastic resin include acrylic resins, acrylic modified polyolefin resin, chlorinated polyolefin resin, vinyl chloride-vinyl acetate copolymer, thermoplastic urethane resin, thermoplastic polyester resin, and polyamide resin. The thermoplastic resin is preferably an acrylic resin. Examples of the acrylic resin include a (meth)acrylic ester homopolymer, a copolymer of two or more different (meth)acrylic ester monomers, and a copolymer of a (meth)acrylic ester and another monomer.

The ionizing radiation-curable resin may contain one or more of polyfunctional (meth)acrylate oligomers and polyfunctional (meth)acrylate monomers. The ionizing radiation-curable resin may contain an oligomer and/or monomer having a polymerizable unsaturated bond in the molecule.

The oligomer is preferably a (meth)acrylate oligomer having a radically polymerizable unsaturated group in the molecule, more preferably a polyfunctional (meth)acrylate oligomer having two or more polymerizable unsaturated bonds in the molecule (two or more functional). Examples of the polyfunctional (meth)acrylate oligomer include polycarbonate (meth)acrylate, urethane (meth)acrylate, epoxy (meth)acrylate, polyester (meth)acrylate, and polyether (meth)acrylate.

The monomer used as the ionizing radiation-curable resin is preferably a (meth)acrylate monomer having a radically polymerizable unsaturated group in the molecule, more preferably a polyfunctional (meth)acrylate monomer. Specific examples of the polyfunctional (meth)acrylate monomer include ethylene glycol di(meth)acrylate, propylene glycol di(meth)acrylate, 1,4-butanediol di(meth)acrylate, 1,6-hexanediol di(meth)acrylate, neopentyl glycol di(meth)acrylate, trimethylolpropane tri(meth)acrylate, dipentaerythritol tri(meth)acrylate, pentaerythritol tri(meth)acrylate, and dipentaerythritol hexa(meth)acrylate.

The thermoplastic resin layer 70 imparts strength to the decorative film 40. The thermoplastic resin layer 70 may have a thickness of 100 μm or more, 200 μm or more, 350 μm or more, or 450 μm or more along the third direction D3. The thickness of the thermoplastic resin layer 70 may be set such that the total thickness of the decorative film 40 along the third direction D3 is 200 μm or more, 300 μm or more, 450 μm or more, 475 μm or more, or 600 μm or more. The thermoplastic resin layer 70 may have a thickness of 1000 μm or less. The thermoplastic resin layer 70 is transparent and imparts visible light transparency to the display sections 22 of the decorative display component 20. The thermoplastic resin layer 70 may have a visible light transmittance of 50% or more.

To improve formability, the thermoplastic resin layer 70 preferably contains a thermoplastic resin, more preferably is made of a thermoplastic resin. Examples of the thermoplastic resin include acrylic resins, polyolefin resins, such as polypropylene and polyethylene, polycarbonate, ABS resin, and vinyl chloride resin. The thermoplastic resin layer 70 may include two or more of these layers.

As indicated by two-dot-dash lines in FIG. 4, the thermoplastic resin layer 70 may have a body 70a and an stick layer 70b. In this example, the thermoplastic resin layer 70 is joined to the second top layer 55 through the stick layer 70b. The material of the thermoplastic resin layer 70 described above can be used as a material of the body 70a. The material of the stick layer 70b may be, for example, a self-sticking material, such as polypropylene or polyethylene.

In this description, the terms “stick” and “adhere” are not distinguished from each other. The term “join” includes “stick,” “adhere”, “weld”, and other similar terms.

The resin portion 32 is joined to the decorative film 40. The resin portion 32 is formed by injection molding while the resin portion 32 is joined to the decorative film 40. In the illustrated example, the resin portion 32 is joined to the thermoplastic resin layer 70. The resin portion 32 is transparent and imparts visible light transparency to the display sections 22 of the decorative display component 20. The resin portion 32 may have a visible light transmittance of 50% or more. The resin portion 32 is made of a thermoplastic resin suitable for injection molding. Examples of the material of the resin portion 32 include polycarbonate resin, acrylic resins, such as polymethyl methacrylate, and ABS resin.

The decorative display component 20 illustrated in FIG. 1 spreads like a sheet in general observation. The decorative display component 20 spreads in the first direction D1 and the second direction D2. The decorative display component 20 includes the elements 32 and 40 laminated in the third direction D3. The decorative film 40 includes the elements 50, 60, 55, and 70 laminated in the third direction D3. In other words, the third direction D3 is the lamination direction. In the illustrated example, the first direction D1, the second direction D2, and the third direction D3 are perpendicular to each other.

Referring to FIG. 1, the decorative display component 20 has a three-dimensional shape. More specifically, the decorative display component 20 bends on both sides in the first direction D1. The decorative display component 20 is not limited to the illustrated example and may have various shapes. In the example illustrated in FIG. 1, the resin portion 32 has a sheet shape spreading along the decorative display component 20. The resin portion 32 is not limited to the illustrated example. The resin portion 32 may have a portion extending out independently of the decorative display component 20 and may have, for example, a fixation claw for attaching the decorative display component 20 at an installation target position.

Next, an example method for manufacturing the decorative display component 20 will be described.

In the method described below, the decorative film 40 without the holes 43 is first produced. In other words, the produced decorative film 40 does not include the non-formation sections 42. Next, the decorative film is joined to the resin portion 32 formed by injection molding to produce a decorative molded article 30. Subsequently, the first top layer 50 and the design layer 60 of the decorative film 40 are partially removed by laser etching. Laser etching forms the holes 43 in the decorative film 40. The holes 43 constitute the non-formation sections 42. The decorative display component 20 is produced accordingly. Part of a surface of the decorative display component 20 that faces an observer is formed by the second top layer 55 exposed in the holes 43 constituting the non-formation sections 42.

In the manufacturing method described below, the decorative molded article 30 is produced by supplying the heated thermoplastic resin into a cavity 92 accommodating the decorative film 40. In the manufacturing method described below, the decorative film 40 is deformed by preforming, and the deformed decorative film 40 is placed in the cavity 92. Each step will be described in more detail.

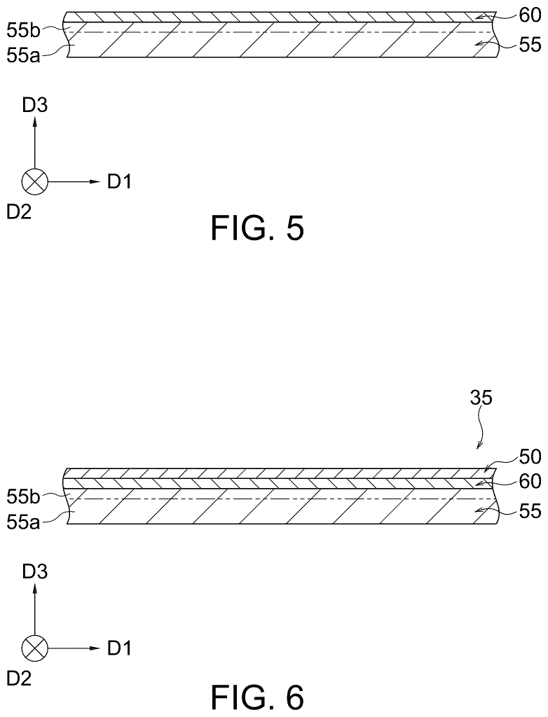

First, a sheet for forming the second top layer 55 is prepared. The material and thickness of the second top layer 55 are as described above. Next, referring to FIG. 5, the design layer 60 is formed on the second top layer 55 by printing, transfer, or other methods. The material and thickness of the design layer 60 are as described above. Subsequently, referring to FIG. 6, the first top layer 50 is formed on the design layer 60. The first top layer 50 is formed by applying a composition containing an ionizing radiation-curable resin to the design layer 60. Next, the composition on the design layer 60 is irradiated with ionizing radiation to cure the composition. This forms the first top layer 50 composed of a cured product of the ionizing radiation-curable resin. A multilayer body 35 illustrated in FIG. 6 is produced accordingly. The produced multilayer body 35 has the second top layer 55, the design layer 60, and the first top layer 50 laminated in this order in the third direction D3.

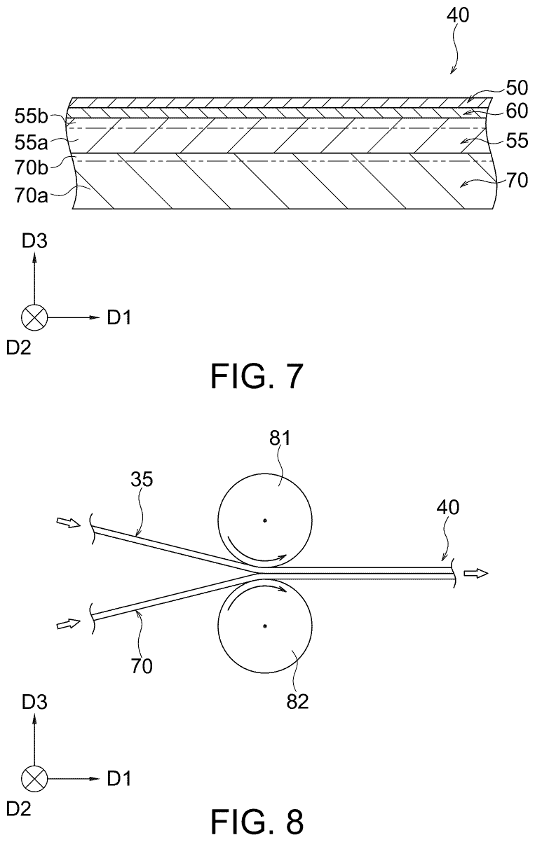

Subsequently, referring to FIG. 7, the thermoplastic resin layer 70 is provided on the second top layer 55 of the multilayer body 35. For example, the sheet like thermoplastic resin layer 70 may be joined to the second top layer 55 by thermal lamination. In this example, first, a sheet of a thermoplastic resin which forms the thermoplastic resin layer 70 is prepared. The material and thickness of the thermoplastic resin layer 70 are as described above. In the example illustrated in FIG. 8, the multilayer body 35 and the thermoplastic resin layer 70 are transferred between a first roll 81 and a second roll 82. The first roll 81 and the second roll 82 are heated with, for example, a built-in heater (not shown). The first roll 81 and the second roll 82 press the multilayer body 35 and the thermoplastic resin layer 70 against each other. When the thermoplastic resin layer 70 passes through between the first roll 81 and the second roll 82, the thermoplastic resin layer 70 is pressed against the multilayer body 35 while being heated. This process causes welding between the multilayer body 35 and the thermoplastic resin layer 70. The decorative film 40 illustrated in FIG. 7 is produced accordingly. The produced decorative film 40 includes the thermoplastic resin layer 70, the second top layer 55, the design layer 60, and the first top layer 50 laminated in this order in the third direction D3. The holes 43 or the non-formation sections 42 are not provided in the produced decorative film 40.

As described above, the thermoplastic resin layer 70 may have the body 70a and the stick layer 70b. The use of the stick layer 70b can improve close contact between the multilayer body 35 and the thermoplastic resin layer 70.

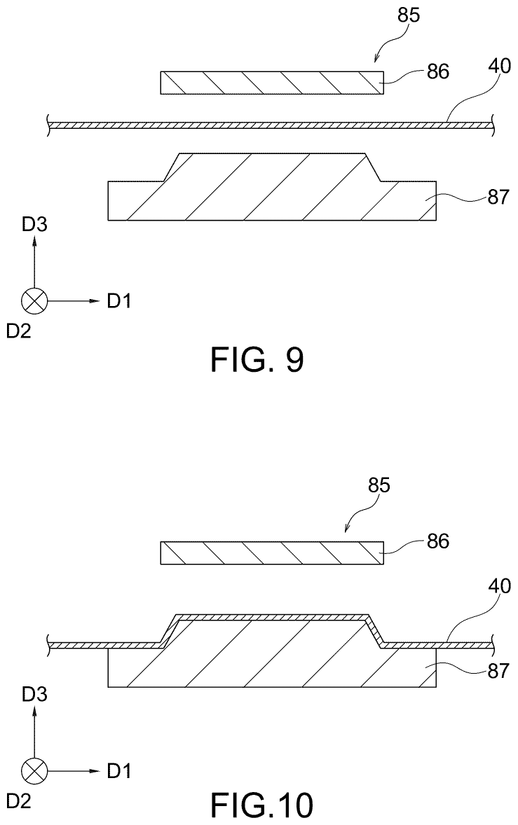

Next, the decorative film 40 is preformed as illustrated in FIG. 9 to FIG. 12. The preforming involves plastic deformation of the decorative film 40 to provide the decorative film 40 with a desired shape. The decorative film 40 is plastically deformed by preforming. The decorative film 40 has a large thickness due to the thermoplastic resin layer 70. Therefore, the decorative film 40 can maintain its shape after preforming. The decorative film 40 after preforming has a shape close to the shape of the decorative display component 20, which is an intended shape. In the example illustrated in FIG. 9 to FIG. 12, vacuum forming is carried out as preforming. Preforming is not limited to this example, and may be any one of various forming processes, such as pressure forming, TOM forming, and bending forming. The decorative film 40 may undergo machining, such as cutting. Furthermore, preforming may be omitted.

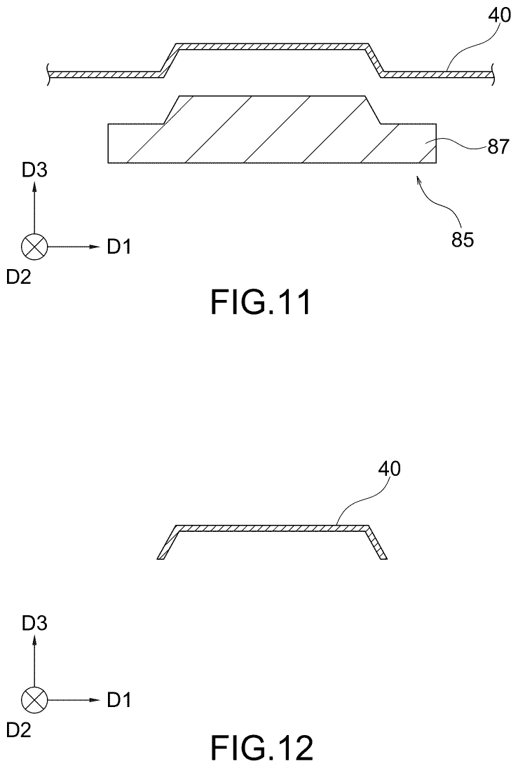

In vacuum forming of the illustrated decorative film 40, the decorative film 40 is softened with heat from a heater 86 of a vacuum forming device 85 as illustrated in FIG. 9. The decorative film 40 is disposed near a die 87 of the vacuum forming device 85. Next, referring to FIG. 10, the decorative film 40 is vacuum-suctioned from many fine pores (not shown) provided with the die 87. The decorative film 40 is thus suctioned against the die 87. As a result, the decorative film 40 can be shaped in conformity with the shape of the die 87. In other words, the shape of the decorative film 40 conforms to the shape of the die 87. Subsequently, the decorative film 40 is cooled. The decorative film 40 solidifies in the formed shape. Next, referring to FIG. 11, the decorative film 40 is taken out of the die 87. Referring to FIG. 12, unnecessary parts are removed from the decorative film 40 taken out of the die 87.

Until trimming in the preforming process illustrated in FIG. 12, a long sheet like product in which multiple decorative films 40 are not separated from each other may be manufactured by roll-to-roll. According to the roll-to-roll manufacturing method, the long decorative film 40 can be supplied to the preforming process. Therefore, the yield rate can be improved, and the production costs can be reduced. In particular, when the design layer 60 is formed by printing using a roll plate, a high yield rate can be achieved independently of the relationship between the diameter of the roll plate and the size of the final product. Unlike the above description, the decorative film 40 may be produced as a separate sheet until trimming in the forming process.

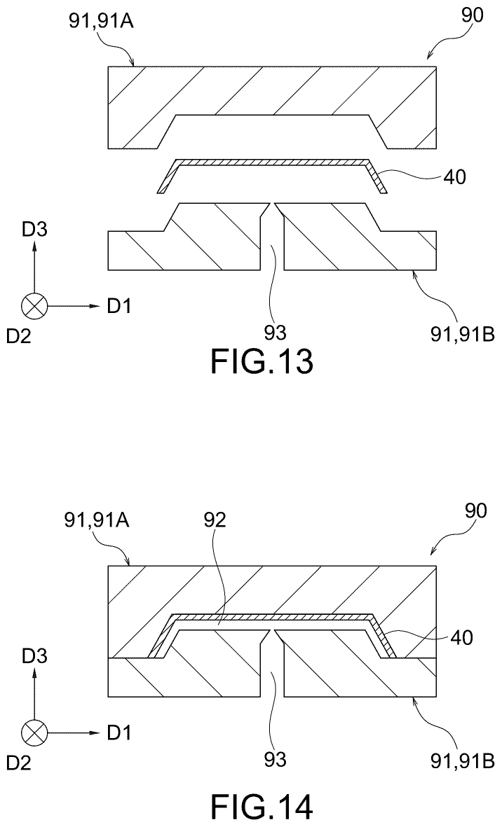

Next, the decorative molded article 30 is manufactured by using the preformed decorative film 40. First, referring to FIG. 13, an injection molding device 90 is prepared. The injection molding device 90 has a mold 91. The mold 91 includes a first mold 91A and a second mold 91B. The first mold 91A and the second mold 91B can be separated from each other as illustrated in FIG. 13, and can be brought close to each other as illustrated in FIG. 14. Referring to FIG. 14, the cavity 92 is formed between the first mold 91A and the second mold 91B in the closed state in which the first mold 91A and the second mold 91B are in contact with each other. The mold 91 has a gate 93 leading to the cavity 92. The gate 93 is connected to a device for supplying an injection resin 33 (not shown). The injection resin 33 is supplied into the cavity 92 through the gate 93. The first mold 91A and the second mold 91B are heated with a heater (not shown) and maintained at high temperature.

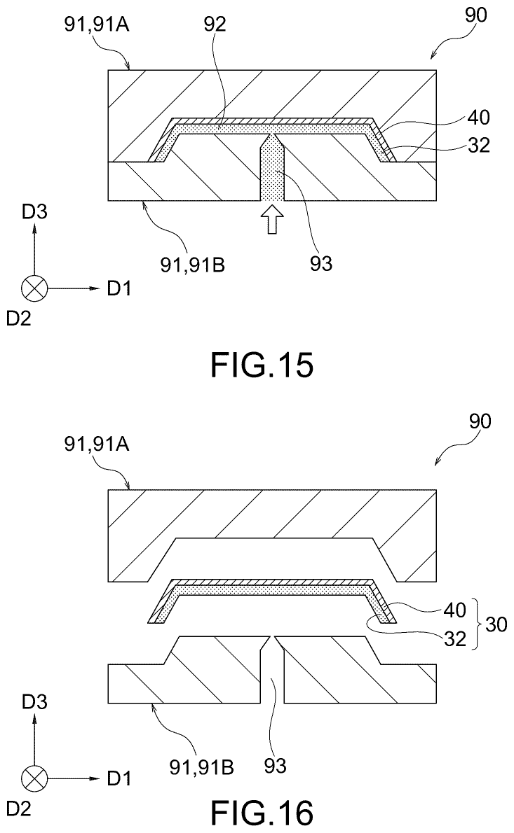

Referring to FIG. 14, the decorative film 40 is placed in the cavity 92 in the mold 91. In the illustrated example, the decorative film 40 is disposed in the cavity 92 such that the decorative film 40 is in contact with the first mold 91A and the thermoplastic resin layer 70 is exposed in the cavity 92. Next, referring to FIG. 15, the molten injection resin 33 is injected into the cavity 92 through the gate 93. The injection resin 33 is cooled in the cavity 92 so that the injection resin 33 is welded to the decorative film 40 and solidified. The solidified injection resin 33 provides the resin portion 32 joined to the thermoplastic resin layer 70 of the decorative film 40. The material and thickness of the resin portion 32 are as described above.

Subsequently, the first mold 91A and the second mold 91B are separated from each other as illustrated in FIG. 16. The decorative molded article 30 including the decorative film 40 and the resin portion 32 is taken out of the cavity 92. The decorative molded article 30 having the decorative film 40 and the resin portion 32 is produced accordingly.

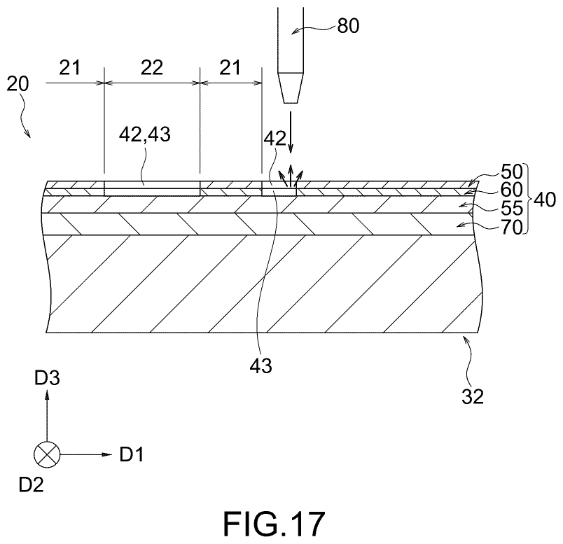

Next, the holes 43 are formed in the decorative film 40. The non-formation sections 42 are formed in the decorative film 40 by providing the holes 43 in the decorative film 40. Referring to FIG. 17, for example, the holes 43 and the non-formation sections 42 may be formed by laser etching using a laser irradiation device 80. In the example illustrated in FIG. 17, the decorative film 40 of the decorative molded article 30 is irradiated with a laser beam emitted from the laser irradiation device 80. In the illustrated example, the laser beam enters the decorative molded article 30 from the first top layer 50 of the decorative film 40. Only the first top layer 50 and the design layer 60 can be removed by adjusting the focusing position of the laser beam emitted from the laser irradiation device 80 according to the distance from the laser irradiation device 80 to the first top layer 50 and the design layer 60 of the decorative molded article 30. When the second top layer 55 has transparency against laser beam, the removal of the second top layer 55 can be suppressed. This enables removal of the first top layer 50 and the design layer 60 while the second top layer 55 remains. The removal of the first top layer 50 and the design layer 60 exposes the second top layer 55. The second top layer 55 exposed in the holes 43 and the non-formation sections 42 of the decorative film 40 forms the surface of the decorative display component 20.

The laser beam used in laser etching is not limited. Laser beams emitted from various types of laser sources can be used. The wavelength of the laser beam used in laser etching is not limited. The laser beam may have a wavelength in the visible light range or may have a wavelength in the infrared range. Preferably, a laser beam that shows a high absorption rate in the design layer 60 and a low absorption rate in the second top layer 55 is used.

The laser etching described above can form the holes 43 and the non-formation sections 42 in the decorative film 40. The decorative display component 20 can be accordingly produced from the decorative molded article 30. The decorative display component 20 thus produced, together with the light source 15, constitutes the decorative display system 10 illustrated in FIG. 1 to FIG. 4. Referring to FIG. 4, the light source 15 faces the display sections 22 of the decorative display component 20 in the third direction D3. Referring to FIG. 3, the light from the light source 15 passes through the display sections 22 of the decorative display component 20 when the light source 15 is turned on. The display sections 22 thus appear bright compared with the state in FIG. 2 where the light source 15 is off.

The design expression of the decorative film 40 using the design layer 60 allows installation of the decorative display system 10 while ensuring the harmony and consistency with the surrounding environment. The range of application of the decorative display system 10 has been rapidly expanding in recent years. The use of the decorative display component 20 enables application of the decorative display system 10 to, for example, automotive interiors, building interiors, furniture, and home appliances, with requires high design quality.

Meanwhile, a decorative display component known in the related art has been manufactured by using, in insert molding, a decorative film having a decorative area with printing and a non-decorative area without printing. This example known in the related art requires positioning the decorative film having a decorative area and a non-decorative area with respect to a mold used for insert molding. When preforming is carried out before insert molding, the decorative film having a decorative area and a non-decorative area needs to be positioned with respect to a device used for preforming. There is another manufacturing method known in the related art, where a decorative display component may be manufactured by attaching a decorative film having a decorative area and a non-decorative area to a preformed resin portion. This example known in the related art requires positioning the decorative film with respect to the resin portion. It is not easy to position a flat decorative film with respect to a device or a resin portion while checking the position of the non-decorative area of the decorative film. If the positioning is not accurate, the display sections deviate from intended positions in the obtained decorative display component. As a result, the design section shows insufficient design expression, and the decorative display component has poor design quality. In addition, the relative position between the display sections of the decorative display component and the light source may be inappropriate. In this case, the pattern of the display sections cannot be properly displayed through effective use of light from the light source, and the decorative display component has poor design quality as a result.

To solve these defects in the related art, the decorative film 40 before forming the holes 43 and the non-formation sections 42 is used in preforming and insert molding according to this embodiment. The holes 43 and the non-formation sections 42 are formed in the decorative film 40 joined to the resin portion 32. Therefore, there is no need to position the flat decorative film 40 with respect to the vacuum forming device 85 and the injection molding device 90 while checking the pattern of the decorative film 40. The decorative molded article 30 needs to be positioned in laser etching. Since the decorative molded article 30 has been subjected to the forming process, the decorative molded article 30 having a three-dimensional shape can be easily and precisely positioned with respect to the laser irradiation device 80. Therefore, the first top layer 50 and the design layer 60 can be precisely removed from desired regions of the decorative molded article 30. This can form the display section 22, which is a non-formation section where neither the first top layer 50 nor the design layer 60 is formed, at appropriate positions of the decorative molded article 30. As a result, the decorative display component 20 can be provided with expected design quality stably and easily, and the decorative display component 20 has high design quality.

In addition, the following defect also has occurred in the related art. In a manufacturing method in the related art, a decorative film having a decorative area and a non-decorative area elongates during insert molding or when attached to a resin portion. The elongation depends on the final shape of a decorative display component and is usually non-uniform. The non-decorative area of the decorative film deforms according to the non-uniformity and degree of elongation. Therefore, the decorative display component in the related art is less likely to display a desired pattern when the resin portion has a complicated three-dimensional shape.

According to this embodiment, the holes 43 and the non-formation sections 42 are formed, by laser etching, in the decorative film 40 joined to the resin portion 32 and spreading along the outer surface of the resin portion 32. Unlike the decorative display component in the related art, the elongation defect does not occur in this embodiment. The holes 43 and the non-formation sections 42 can be formed in desired shapes, which enables a desired pattern.

In addition, the following defect also has occurred in the related art. The edge of the decorative area formed by printing in the decorative display component in the related art finely meanders, resulting in a lack of clarity. In the decorative display component in the related art, the display observed with the light source on may also lack clarity.

According to this embodiment, the holes 43 and the non-formation sections 42 are formed by laser etching. Therefore, the edges of the first top layer 50 and the design layer 60 leading to the non-formation sections 42 can be made clear. For this, the display observed with the light source 15 on is also clear.

In addition, the following defect also has occurred in the related art. In a decorative display component in the related art, a decorative film may be produced by printing using a roll plate. The produced decorative film in the related art in a long state before cutting has non-decorative areas spaced at regular intervals. Therefore, the yield rate of the decorative film in the related art may be significantly reduced depending on the size of the actually produced decorative display component.

According to this embodiment, the hole 43 and the non-formation section 42 can be formed in desired regions of the decorative film 40 joined to the resin portion 32. Therefore, the yield rate of the decorative film 40 can be significantly improved regardless of the size of the decorative display component 20.

Referring to FIG. 4, in the decorative display system 10, the first top layer 50 in the design sections 21 forms the surface of the decorative display component 20. The first top layer 50 contains a cured product of an ionizing radiation-curable resin and has physical properties required for the surface layer. In the illustrated decorative display system 10, the second top layer 55 is exposed in the display sections 22 and forms the surface of the decorative display component 20. Therefore, the second top layer 55 may be produced by using a material having physical properties required for the surface layer of the decorative display component 20. The second top layer 55 may have the base layer 55a and the cover layer 55b, and the cover layer 55b may have physical properties required for the surface layer of the decorative display component 20. These examples can eliminate the necessity of providing a protective layer, such as a coating, on the decorative display component 20 after laser etching.

For example, the second top layer 55 or the cover layer 55b may be made of an acrylic resin, more specifically, polymethyl methacrylate. Acrylic resins, such as polymethyl methacrylate, have been used as the surface layers of interior materials, e.g., as the surface layers of interior materials used in automobiles, for many years, and have physical properties required for interior materials.

A protective layer, such as a coating, if provided on the decorative display component 20 after laser etching, flattens the surface of the decorative display component 20. Since there is no need to provide a protective layer after laser etching, the first top layer 50 can make the surface of the decorative display component 20 an uneven surface. To further improve design quality, an additional technique can be applied to the decorative display component 20.

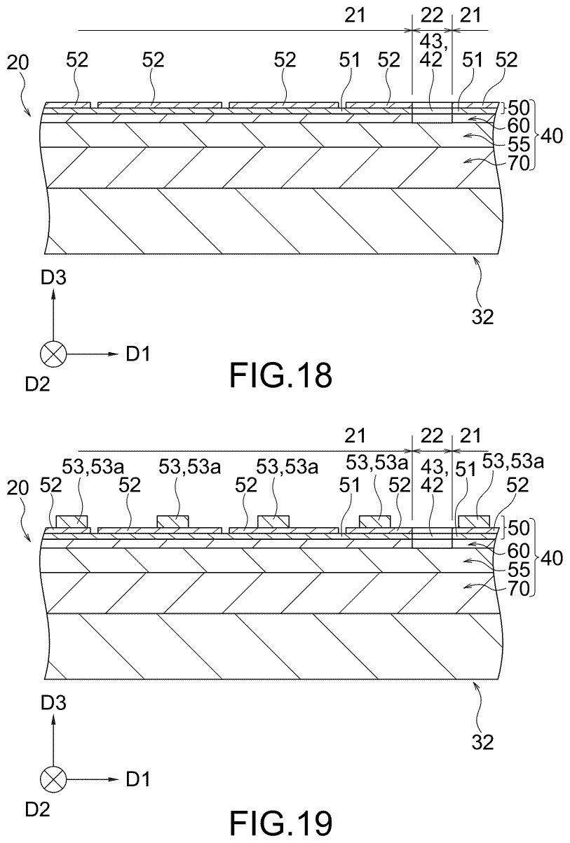

For example, referring to FIG. 18, the first top layer 50 may have a first layer 51 laminated with the design layer 60 and a second layer 52 laminated with part of the first layer 51. In this example, the second layer 52 is disposed on part of the first layer 51. The first layer 51 and the second layer 52 are laminated in this order with the design layer 60. At least part of the first layer 51 is not covered by the second layer 52 and may form the surface of the decorative display component 20. The first layer 51 and the second layer 52 have different glossiness. The first layer 51 and the second layer 52 both contain a cured product of an ionizing radiation-curable resin. The glossiness of the first layer 51 may be different from that of the second layer 52. For example, when the first layer 51 and the second layer 52 contain different amounts of a matting agent, such as the inorganic particles or the resin particles described above, the first layer 51 and the second layer 52 have different glossiness. When the first layer 51 and the second layer 52 contain different types of particles, the first layer 51 and the second layer 52 have different glossiness. The first layer 51 may contain inorganic particles, and the second layer 52 may contain resin particles. When the first layer 51 and the second layer 52 contain matting agents having different average particle sizes, the first layer 51 and the second layer 52 have different glossiness. Two or more of the above methods for generating a difference in glossiness between the first layer 51 and the second layer 52 may be used. The first layer 51 may have a higher glossiness than the second layer 52. The second layer 52 may have a higher glossiness than the first layer 51. The glossiness is a value measured at an angle of incidence of 20° in accordance with JIS Z 8741 by using Gloss meter VG7000 available from Nippon Denshoku Industries Co., Ltd. For example, when the design layer 60 has a wood grain pattern, the first layer 51 having a lower glossiness may be exposed in the conduit parts of the wood grain pattern, and the second layer 52 having a higher glossiness may be provided in parts other than the conduits of the wood grain pattern. According to this example, the design of the wood grain pattern or other patterns can be further improved by disposing the second layer 52 according to the design displayed by the design layer 60.

The first layer 51 may have a ten-point average roughness RzJIS of 0.7 μm or more and 5 μm or less. The second layer 52 may have a ten-point average roughness RzJIS of 2 μm or more and 7 μm or less. The second layer 52 may have a larger ten-point average roughness RzJIS than the first layer 51. The second layer 52 may have a larger ten-point average roughness RzJIS than the first layer 51, and a difference in ten-point average roughness RzJIS between the second layer 52 and the first layer 51 may be 0.7 μm or more. The design quality can be improved by setting the ten-point average roughness RzJIS of the first layer 51 and the ten-point average roughness RzJIS of the second layer 52 as described above. For example, a combination with the design layer, such as a wood grain pattern, can reduce an artificial impression and create a natural appearance. The ten-point average roughness RzJIS is defined in JIS B 0601:2001.

Referring to FIG. 19, the decorative film 40 may further have a projection layer 53 laminated on the second layer 52. The projection layer 53 has a plurality of projecting parts 53a spaced apart from each other. In the illustrated example, the second layer 52 is located between the projection layer 53 and the design layer 60. The projection layer 53 imparts good tactile sensation. To provide good tactile sensation, the thickness of the projecting parts 53a in the third direction D3 may be 5 μm or more, 10 μm or more, or 20 μm or more. To provide good tactile impression, the thickness of the projection layer 53 in the third direction D3 may be 50 μm or less.

The projection layer 53 is located on the outermost side in the third direction D3 in the example illustrated in FIG. 19, but the projection layer 53 is not limited to this example. The projection layer 53 may be located between the first layer 51 and the second layer 52. The projection layer 53 may be located between the first layer 51 and the design layer 60. The projection layer 53 is used in combination with the first top layer 50 including the first layer 51 and the second layer 52 in the example illustrated in FIG. 19, but this is merely an example. The projection layer 53 may be used in combination with a first top layer 50 composed of a single layer.

The projection layer 53 may be produced by forming the projecting parts 53a by printing a coating liquid containing inorganic particles. The projection layer 53 may be produced by forming the projecting parts 53a by embossing. When the projecting parts 53a are formed by embossing, the projecting parts 53a may be integrally formed with the first layer 51.

In the embodiments described above, the decorative film 40 is a decorative film that undergoes laser etching, and the decorative film 40 includes: the first top layer 50 containing a cured product of an ionizing radiation-curable resin; the transparent second top layer 55 laminated with the first top layer 50; and the design layer 60 located between the first top layer 50 and the second top layer 55. The decorative molded article 30 has the decorative film 40 and the resin portion 32 laminated with the decorative film 40. The decorative display component 20 has the decorative molded article 30 or the decorative film 40, and the second top layer 55 is exposed in the holes 43 constituting the non-formation sections 42 of the first top layer 50 and the design layer 60 to form the surface of the decorative display component 20. The decorative display system 10 has the decorative display component 20 and the light source 15, which projects light to the decorative display component 20 from the opposite side of the first top layer 50. In the embodiment described above, the method for manufacturing the decorative display component 20 has a step of producing the decorative display component 20 by joining the decorative film 40 to the resin portion 32 formed by injection molding, and a step of partially removing the first top layer 50 and the design layer 60 by laser etching so that the second top layer 55 forms part of the surface.

According to this embodiment, the decorative molded article 30 can be produced by joining the decorative film 40 to the resin portion 32. Furthermore, the decorative display component 20 can be manufactured by laser-etching the decorative molded article 30. For example, the decorative molded article 30 having a three-dimensional shape can be positioned with respect to a laser etching machine stably and easily. Therefore, the first top layer 50 and the design layer 60 can be precisely removed from desired regions of the decorative molded article 30. This can form the display sections 22, which are the holes 43 and the non-formation sections 42 of the first top layer 50 and the design layer 60, at appropriate positions of the decorative molded article 30. As a result, the decorative display component 20 can be provided with expected design quality stably and easily, and the design quality of the decorative display component 20 can be improved.

The embodiments are described with reference to specific examples, but the embodiments are not limited by the specific examples described above. The embodiments described above can be carried out in various other specific examples, and various omissions, substitutions, changes, and additions can be made without departing from the spirit of the embodiment.

Exemplary modifications will be described below with reference to the drawings. In the following description and the drawings used in the following description, parts that may have the same configuration as in the specific examples described above are assigned with the same reference signs used for the corresponding parts in the specific examples described above.

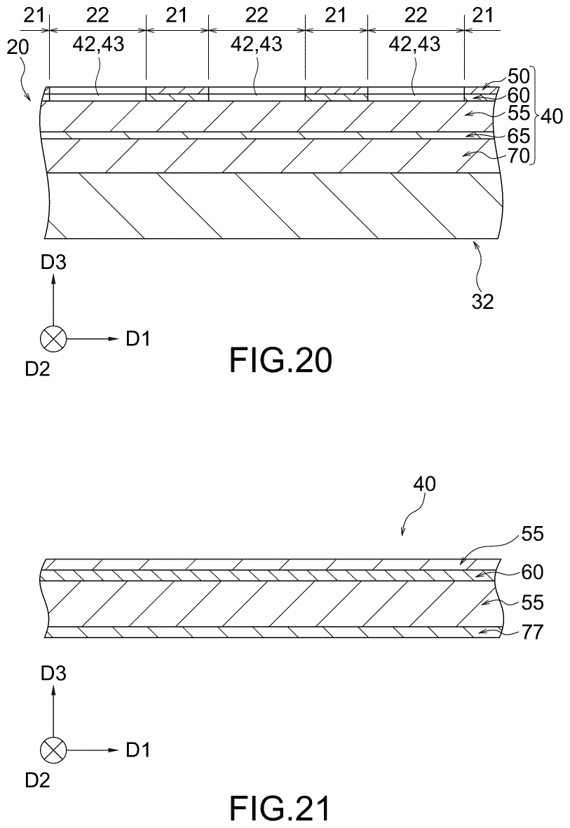

Referring to FIG. 20, the decorative film 40 may further include a second design layer 65 laminated on the second top layer 55. The second top layer 55 is located between the design layer 60 and the second design layer 65 in the third direction D3. The second design layer 65 may display the same design as the design layer 60. The second design layer 65 is transparent so that it may impart visible light transparency to the display sections 22 of the decorative display component 20. The second design layer 65 may be formed by printing or transfer using the same material as the design layer 60. The second design layer 65 may display a wood-grain or marble pattern, a metallic appearance, or a geometric pattern.

In the specific example described above, insert molding is performed by using the decorative film 40 after preforming of the decorative film 40. As an alternative to this example, preforming may be omitted. In this example, the resin portion 32 joined to the decorative film 40 may be formed by placing the flat decorative film 40 in the cavity 92 and supplying the molten injection resin 33 into the cavity 92. Such injection molding may also be referred to as thermoject molding. During this injection molding, the decorative film 40 may be deformed in conformity with the shape of the cavity 92.

When the decorative film 40 having the projection layer 53 is subjected to insert molding, a masking layer having holes or recesses that receive the projecting parts 53a may be used. Flattening of the projecting parts 53a can be suppressed by placing the decorative film 40 in the cavity 92 with the masking layer overlaid on the projection layer 53.

The thermoplastic resin layer 70 may be omitted from the decorative film 40. For example, when the preforming described above is omitted, it is unnecessary to provide the thermoplastic resin layer 70 for the purpose of maintaining the shape after preforming. Therefore, the thermoplastic resin layer 70 may be omitted when preforming is omitted. Referring to FIG. 21, the decorative film 40 may have a heat seal layer 77 instead of the thermoplastic resin layer 70 to improve close contact between the decorative film 40 and the resin portion 32. The heat seal layer 77 preferably contains a thermoplastic resin, more preferably is made of a thermoplastic resin. For example, the heat seal layer 77 may be welded to the second top layer 55 by heating and pressing a thermoplastic resin film against the second top layer 55. The heat seal layer 77 preferably has a lower glass transition temperature than the second top layer 55. Examples of the material of the heat seal layer 77 include polyolefin resins, such as polypropylene and polyethylene, vinyl chloride resin, and ABS resin.

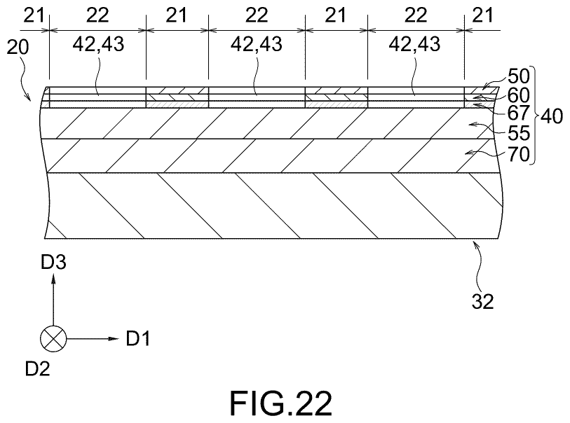

Referring to FIG. 22, the decorative film 40 may further include a masking layer 67 located between the second top layer 55 and the design layer 60 in the third direction D3. The masking layer 67 contains a binder resin and a dark pigment, such as carbon black, dispersed in the binder resin. The masking layer 67 may have a lower visible light transmittance than the design layer 60. The masking layer 67 may have visible light-shielding properties. The masking layer 67 can absorb a laser beam emitted in laser etching at high absorption rate. This enables stable removal of the first top layer 50, the design layer 60, and the masking layer 67 in regions irradiated with a laser beam. The formed holes 43 stably pass through the first top layer 50, the design layer 60, and the masking layer 67. The residue remaining in the holes 43 can be reduced by increasing the absorption rate of the laser beam in the masking layer 67. This enables the image corresponding to the shapes of the non-formation sections 42 to be clearly observed with the light source 15 on. The masking layer 67 remains in the design sections 21, and the remaining masking layer 67 absorbs light from the light source when the light source 15 is on. This suppresses light emission from an area other than the non-formation sections 42 with the light source 15 on, so that the outlines of the non-formation sections 42 can be clearly displayed.

The masking layer 67 may contain light absorbing particles. Examples of the light absorbing particles include carbon black. The amount of carbon black in the masking layer 67 may be 0.05 g/m² or more and 2 g/m² or less, or 0.05 g/m² or more and 1.5 g/m² or less. When the amount of carbon black in the masking layer 67 is 0.05 g/m² or more, the laser beam may be stably absorbed by the masking layer 67. This enables stable removal of the first top layer 50, the design layer 60, and the masking layer 67. The residue remaining in the formed holes 43 can be reduced. When the amount of carbon black in the masking layer 67 is 2 g/m² or less, the size of the formed holes 43 is unlikely to excessively increase, and the non-formation sections 42 can be precisely formed in desired regions.

During laser etching, the laser beam passes through the first top layer 50 and enters the design layer 60 in the illustrated example. Laser etching is not limited to this example, and the laser beam may pass through the second top layer 55 and may enter the design layer 60 or the masking layer 67.

### REFERENCE SIGNS LIST

D1: first direction, D2: second direction, D3: third direction, 10: decorative display system, 15: light source, 20: decorative display component, 21: design section, 22: display section, 30: decorative molded article, 32: resin portion, 33: injection resin, 35: multilayer body, 40: decorative film, 42: non-formation section, 43: hole, 50: first top layer, 51: first layer, 52: second layer, 53: projection layer, 55: second top layer, 55a: base layer, 55b: cover layer, 60: design layer, 65: second design layer, 67: masking layer, 70: thermoplastic resin layer, 70a: body, 70b: stick layer, 77: heat seal layer, 80: laser irradiation device, 81: first roll, 82: second roll, 85: vacuum forming device, 86: heater, 87: die, 90: injection molding device, 91: mold, 91A: first mold, 91B: second mold, 92: cavity, 93: gate

1. A decorative film that undergoes laser etching, comprising:
a first top layer containing a cured product of an ionizing radiation-curable resin;
a transparent second top layer laminated with the first top layer; and
a design layer located between the first top layer and the second top layer.

2. The decorative film according to claim 1, wherein the second top layer forms a surface of the decorative film together with the first top layer after the first top layer and the design layer are partially removed by the laser etching.

3. The decorative film according to claim 1, further comprising a thermoplastic resin layer laminated with the second top layer and containing a thermoplastic resin,
wherein the second top layer is located between the design layer and the thermoplastic resin layer.

4. (canceled)

5. (canceled)

6. The decorative film according to claim 1, wherein the second top layer contains an acrylic resin.

7. The decorative film according to claim 1, wherein
the second top layer has a base layer containing an acrylonitrile-butadiene-styrene copolymer and a cover layer covering the base layer, and
the cover layer is located between the base layer and the design layer.

8. The decorative film according to claim 1, wherein
the second top layer has a base layer containing an acrylic resin and a cover layer covering the base layer, and
the cover layer is located between the base layer and the design layer.

9. The decorative film according to claim 1, wherein
the first top layer has a first layer and a second layer laminated with part of the first layer,
the first layer and the second layer are laminated in this order with the design layer, and
the first layer and the second layer have different glossiness.

10. The decorative film according to claim 9, wherein
the first top layer further has a projection layer having a plurality of projecting parts,
the plurality of projecting parts is spaced apart from each other, and
the projecting parts have a thickness of 5 μm or more and 50 μm or less.

11. The decorative film according to claim 1, wherein a surface constituted by the first top layer has unevenness in the decorative film according to an embodiment of the present disclosure.

12. The decorative film according to claim 1, further comprising a second design layer laminated with the second top layer,
wherein the second top layer is located between the design layer and the second design layer.

13. A decorative molded article comprising:
the decorative film according to claim 1; and
a resin portion laminated with the decorative film and containing a thermoplastic resin.

14. A decorative display component comprising the decorative molded article according to claim 13,
wherein the second top layer is exposed from a hole passing through the first top layer and the design layer.

15. A decorative display component comprising:
a decorative film; and
a resin portion laminated with the decorative film and containing a thermoplastic resin,
wherein the decorative film includes:
a first top layer containing a cured product of an ionizing radiation-curable resin;
a transparent second top layer laminated with the first top layer; and
a design layer located between the first top layer and the second top layer,
the second top layer is located between the design layer and the resin portion, and
the second top layer is exposed from a hole passing through the first top layer and the design layer.

16. The decorative display component according to claim 14, wherein the second top layer is exposed from the hole provided in the first top layer and the design layer to form a surface of the decorative display component.

17. The decorative display component according to claim 15, wherein the resin portion has a larger thickness than the second top layer.

18. A decorative display system comprising:
the decorative display component according to claim 15; and
a light source that emits light to the decorative display component.

19. A method for manufacturing a decorative display component, the method comprising:
a step of producing a decorative molded article by joining the decorative film according to claim 1 to a resin portion formed by injection molding; and
a step of partially removing the first top layer and the design layer by laser etching so that the second top layer forms part of a surface.

20. The method for manufacturing a decorative display component according to claim 19, wherein the step of producing the decorative molded article involves supplying a heated thermoplastic resin into a cavity accommodating the decorative film to produce the decorative molded article.

21. The method for manufacturing a decorative display component according to claim 20, further comprising a step of preforming the decorative film to deform the decorative film,
wherein the preformed decorative film is placed in the cavity.

22. The method for manufacturing a decorative display component according to claim 19, further comprising a step of producing the decorative film,
wherein the step of producing the decorative film has a step of forming the design layer on the second top layer by printing, and a step of applying a composition containing an ionizing radiation-curable resin onto the design layer and curing the composition.
